(19) United States
(12) Patent Application Publication
(10) Pub. No.: US 2026/0078467 A1
(43) Pub. Date: Mar. 19, 2026

(54) SYSTEMS AND METHODS TO REMOVE WASTE CONTAMINANTS FROM ORE CONCENTRATES

(71) Applicant: The Trustees of Columbia University in the City of New York, New York, NY (US)

(72) Inventors: ALAN WEST, Tenafly, NJ (US); SCOTT BANTA, Fairfield, CT (US); CHARLES KIM, New York, NY (US); BRIAN CHRISTOPHER DONOVAN, San Francisco, CA (US); JEFFREY P. FITTS, New York, NY (US); Curtis SIRKOCH, Monaca, PA (US)

(73) Assignee: The Trustees of Columbia University in the City of New York, New York, NY (US)

(21) Appl. No.: 19/398,957

(22) Filed: Nov. 24, 2025

Related U.S. Application Data
(63) Continuation of application No. PCT/US2024/031014, filed on May 24, 2024.
(60) Provisional application No. 63/468,765, filed on May 24, 2023.
(60) Provisional application No. 63/539,901, filed on Sep. 22, 2023.
(60) Provisional application No. 63/651,367, filed on May 23, 2024.

(51) Int. Cl. C22B 3/00; C22B 3/08

(52) U.S. Cl. CPC C22B 23/0461; C22B 3/08

(57) ABSTRACT

Enriched metal concentrates and metal products are produced at standard temperature and pressure via sequential treatment of metal concentrates with chemical reducers such as vanadium (V(II)) and chromium (Cr(II)) and chemical oxidizers (Ce(IV)). Naturally occurring ores such as pentlandite, pyrrhotite, chalcopyrite, etc. include concentrations of iron and sulfur that are preferentially leached via reaction with the chemical reducers. The resulting products are enriched for target metals, such as nickel, and can be further reacted with chemical oxidizers to recover metal leachates. Additional ferric iron ion leaching can isolate high concentrations of copper metal products as well. Lower-quality minerals can be converted to higher-quality concentrates as demand for higher-quality feedstocks increases yet the available of those feedstocks decreases. The chemical reducers and oxidizers can be replenished electrochemically for reuse with additional metal concentrates, decreasing the overall costs and material wastes.

### CROSS-REFERENCE TO RELATED APPLICATIONS

This application is a continuation of International Patent Application No. PCT/US2024/031014, filed May 24, 2024, which claims the benefit of U.S. Provisional Patent Application Nos. 63/651,367, May 23, 2024; 63/468,765, filed May 24, 2023; and 63/539,901, filed Sep. 22, 2023, which are incorporated by reference as if disclosed herein in their entireties.

### STATEMENT REGARDING FEDERALLY SPONSORED RESEARCH AND DEVELOPMENT

This invention was made with U.S. Government support under Grant Number DE-AR0001706 awarded by the U.S. Department of Energy. The United States Government has certain rights in the invention.

### BACKGROUND

The demand for nickel (Ni) is growing worldwide, predominantly due to an increased stainless-steel market. The demand for nickel will increase by as much as a factor of 5-10 due to the energy transition for climate mitigation. In an effort to meet the growing demand for high-quality feedstocks, numerous processes and strategies have been developed to extract and purify Ni-containing products from naturally occurring ores and industrial byproducts. The parameters for recovery of nickel from natural and man-made sources depend on the grade and complexity of the Ni-containing source.

Thermophiles have been utilized to improve the dissolution rates of valuable metals including copper and nickel. Biological metallurgy is effective for Ni recovery and poses promising methods for future research and development. Ion exchange also enables improved extraction and purification of nickel.

However, nickel pricing is high relative to other metals such as copper, and the state of art processing of nickel is also less optimized than for copper. The extraction of nickel from sulfides is as a major technological hurdle for cheaper Ni production. The main methods for extracting nickel are metallurgical, including pyrometallurgy and hydrometallurgy. These methods typically involve smelting, leaching, and purification. Smelting is used in the mining industry to process desired metals such as copper, nickel, and cobalt into their pure and final form often from sulfidic minerals. These pyrometallurgical processes have been used since ore refining began and can be costly, use vast amounts of fuel, and release harmful environmental toxins.

Base metals generally come from sulfidic and ferrous ore deposits. Ni-sulfides such as pentlandite are noted mineral sources of nickel. Previous work has not found an effective and economical means of rapidly leaching Ni at room temperature with high yields. Current Ni-producing methods involving smelters or high-temperature autoclaves utilize high temperatures and pressures with long residence times. Utilizing high pressures allow processes above 100° C., but also results in more expensive reactors, increased energy costs, and increased overall capital expense per amount of Ni recovered. This results in relatively low Ni yield, is prohibitive to Ni production, and has detrimental environmental impacts.

Investments in smelters can be in the billions of dollars, and there are thus major incentives to extend the life of a smelter. Commercial operation of the smelter benefits greatly from close control of the mineral-concentrate feedstock, and pricing is set at least in part based on composition. Copper smelters will have a range of Cu:Fe:S weight percentages in or to achieve efficacious operation. Similarly, nickel smelters have an operating range of Ni:Fe:S weight percentages in order to be effective.

As naturally-occurring deposits of target metal-containing ores are exhausted, ore quality, i.e., metal content in the ore, is expected to significantly decrease. This will drastically impact smelting processes operating in the above-identified strict ratios of metals to gangue material. Smelting operations will suffer significantly from declining ore grades. It is believed that as the grade of resources declines, it may difficult for mining operators to achieve the desired composition range (grade) targets without significant reductions in yields (the percentage of critical materials extracted from the ores), increased costs, and greater environmental detriment.

### SUMMARY

Aspects of the present disclosure are directed to a method of leaching one or more metals from sulfide-containing minerals. In some embodiments, the method includes providing a composition including one or more metal concentrates, the composition including a concentration of iron, a concentration of sulfur, and a concentration of a target metal; reacting the metal concentrate with a first solution including one or more chemical reducers to form a leached metal concentrate; isolating a first leachate from the leached metal concentrate, the first leachate including iron, sulfur, or combinations thereof at an elevated concentration relative to the metal concentrate; and recovering the leached metal concentrate as a product enriched for the target metal. In some embodiments, the method includes treating the metal concentrate with one or more acids, wherein the one or more acids includes between about 0.1 M and about 1.0 M H₂SO₄. In some embodiments, the method includes contacting the leached metal concentrate with a second solution including one or more chemical oxidizers; isolating a second leachate, the second leachate including a target metal; and isolating a target metal product from the second leachate. In some embodiments, the method includes isolating a concentration of a reduced chemical oxidizer; providing at least a portion of the reduced chemical oxidizer to an electrochemical device; oxidizing the reduced chemical oxidizers at the electrochemical device to a concentration of recycled chemical oxidizer; and contacting at least a portion of the recycled chemical oxidizer with the leached metal concentrate. In some embodiments, the method includes contacting the leached metal concentrate with an additional solution including a concentration of ferric iron ions; and isolating an additional leachate from the leached metal concentrate, the additional leachate including copper at an elevated concentration relative to the leached metal concentrate. In some embodiments, reacting the metal concentrate with a first solution including one or more chemical reducers to form a leached metal concentrate occurs at about standard temperature, standard pressure, or combinations thereof. In some embodiments, reacting the metal concentrate with a first solution including one or more chemical reducers to form a leached metal concentrate has a reaction time between about 1 minute and about 60 minutes.

In some embodiments, the metal concentrate includes pentlandite, pyrrhotite, Cu Rougher Tails, or combinations thereof. In some embodiments, the target metal includes nickel, cobalt, or combinations thereof. In some embodiments, the one or more chemical reducers includes V(II), Cr(II), or combinations thereof. In some embodiments, the one or more chemical oxidizers includes Ce(IV), ferric iron ions, or combinations thereof. In some embodiments, the metal concentrate further comprises chalcopyrite.

Aspects of the present disclosure are directed to a system for leaching one or more metals from sulfide-containing minerals. In some embodiments, the system includes a source of a composition including one or more metal concentrates, the composition including a concentration of iron, a concentration of sulfur, and a concentration of a target metal; one or more reduction reactors in communication with the source of a composition and including a first solution, the first solution including one or more chemical reducers; a first leachate effluent stream, the first leachate effluent stream including iron, sulfur, or combinations thereof at an elevated concentration relative to the metal concentrate; and a leached metal concentrate stream including a product enriched for the target metal relative to the metal concentrate. In some embodiments, the system includes an acid inlet stream in fluid communication with the reduction reactor, the acid including between about 0.1 M and about 1.0 M H₂SO₄. In some embodiments, the system includes one or more oxidation reactors in communication with the leached metal concentrate stream and including a second solution, the second solution including one or more chemical oxidizers. In some embodiments, the system includes an electrochemical device in fluid communication with the reduction reactor, the oxidation reactor, or combinations thereof, and one or more recycle streams configured to return recycled chemical reducers to the reduction reactor, recycled chemical oxidizers to the oxidation reactor, or combinations thereof. In some embodiments, the system includes an additional leachate effluent stream, the additional leachate effluent stream including copper at an elevated concentration relative to the metal concentrate.

In some embodiments, the metal concentrate includes pentlandite, pyrrhotite, Cu Rougher Tails, or combinations thereof. In some embodiments, the target metal includes nickel, cobalt, or combinations thereof. In some embodiments, the one or more chemical reducers includes V(II), Cr(II), or combinations thereof. In some embodiments, the one or more chemical oxidizers includes Ce(IV), ferric iron ions, or combinations thereof. In some embodiments, the metal concentrate further comprises chalcopyrite.

Aspects of the present disclosure are directed to a method of leaching one or more metals from sulfide-containing minerals. In some embodiments, the method includes providing a composition including a nickel concentrate; contacting the composition with an acid to form a treated composition, the acid including between about 0.1 M and about 1.0 M H₂SO₄; contacting the treated composition with a first solution including one or more chemical reducers to form a leached nickel concentrate; isolating a first leachate from the leached nickel concentrate, the first leachate including iron, sulfur, or combinations thereof at an elevated concentration relative to the nickel concentrate; contacting the leached nickel concentrate with a second solution including one or more chemical oxidizers; isolating a second leachate, the second leachate including nickel at an elevated concentration relative to the nickel concentrate; and isolating a nickel metal product from the second leachate. In some embodiments, the one or more chemical reducers includes the one or more chemical reducers includes V(II), Cr(II), or combinations thereof, and the one or more chemical oxidizers includes Ce(IV), ferric iron ions, or combinations thereof. In some embodiments, the nickel concentrate includes pentlandite, pyrrhotite, Cu Rougher Tails, or combinations thereof.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a chart of a method of leaching one or more metals from sulfide-containing minerals according to embodiments of the present disclosure;

FIGS. 2A-2B are graphs showing preferential leaching of iron from metal concentrates via reaction with chemical reducers according to embodiments of the present disclosure;

FIG. 3 is a graph showing an x-ray diffraction analysis of solid leached metal concentrates produced via reaction with chemical reducers according to embodiments of the present disclosure;

FIGS. 4A-4B are graphs showing preferential leaching of iron from metal concentrates via reaction with chemical reducers according to embodiments of the present disclosure;

FIG. 4C is a graph showing an x-ray diffraction analysis of solid leached nickel-containing metal concentrates produced via reaction with chemical reducers according to embodiments of the present disclosure;

FIG. 5 is a graph showing iron leaching from metal concentrates via reaction with chemical reducers according to embodiments of the present disclosure;

FIG. 6 is a graph showing nickel leaching from treated metal concentrates via reaction with chemical oxidizers according to embodiments of the present disclosure;

FIG. 7 is a graph showing nickel leaching from treated metal concentrates via reaction with chemical oxidizers according to embodiments of the present disclosure;

FIG. 8 is a chart of a method of leaching one or more metals from sulfide-containing minerals according to embodiments of the present disclosure; and

FIG. 9. is a schematic representation of a system for leaching one or more metals from sulfide-containing minerals.

### DETAILED DESCRIPTION

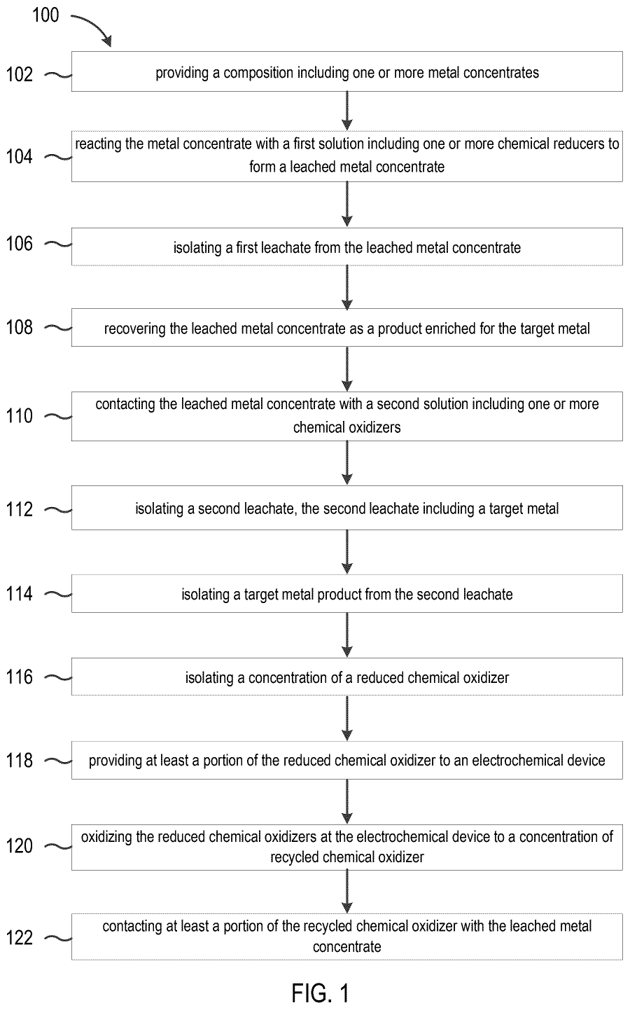

Referring now to FIG. 1, some embodiments of the present disclosure are directed to a method 100 of leaching one or more metals from sulfide-containing minerals. In some embodiments, the one or more metals include nickel, cobalt, or combinations thereof. In some embodiments, the one or more metals include copper. In some embodiments, the one or more metals include at least one of nickel and cobalt, and further include copper. In some embodiments, the sulfide-containing minerals include concentrations of nickel, cobalt, or combinations thereof. In some embodiments, the sulfide-containing minerals include a concentration of copper. In some embodiments, the sulfide-containing minerals include concentrations of at least one of nickel and cobalt, and further contain a concentration of copper. In some embodiments, the sulfide-containing minerals include one or more metal concentrates, as will be described in greater detail below.

In some embodiments, at 102, a composition is provided. In some embodiments, the composition includes a mixture of solids. In some embodiments, the composition includes one or more metal concentrates. As used herein, the term “metal concentrate” refers to a medium including a concentration of a target metal, e.g., nickel, cobalt, copper, etc., the extraction of which is desired. In some embodiments, the metal concentrate is a metal-containing mineral or combination of metal-containing minerals. In some embodiments, the composition is naturally occurring, man-made, or combinations thereof. In some embodiments, the metal concentrate is naturally occurring, man-made, or combinations thereof. In some embodiments, the composition includes a concentration of iron, a concentration of sulfur, a concentration of the target metal, or combinations thereof.

As discussed above, in some embodiments, the metal concentrates include nickel, cobalt, or combinations thereof. In some embodiments, the metal concentrates include copper. In some embodiments, the metal concentrates include at least one of nickel and cobalt, and further includes copper. In some embodiments, the metal concentrates include a concentration of iron, a concentration of sulfur, a concentration of the target metal, or combinations thereof. In some embodiments, the metal concentrate includes pentlandite, pyrrhotite, Cu Rougher Tails, or combinations thereof. In some embodiments, the metal concentrate includes chalcopyrite. In some embodiments, the metal concentration includes at least one of pentlandite, pyrrhotite, and Cu Rougher Tails, and further includes chalcopyrite. In some embodiments, the sulfide-containing mineral includes metal-containing substrates such as F1015: Cu Rougher Tails (0.7% Cu, 15.7% Ni, 30.6% S, 44.2% Fe).

At 104, at least a portion of the composition, e.g., a nickel concentrate, is contacted with a first solution configured to leach one or more target components therefrom. In some embodiments, the first solution includes one or more chemical reducers. In some embodiments, at least a portion of the metal concentrate is reacted with the first solution, e.g., the chemical reducers. The reaction between the components of the metal concentrate and the chemical reducers form a first leachate and a leached metal concentrate. In some embodiments, the first solution is contacted 104 with the composition for about 1 hour, about 2 hours, about 3 hours, about 4 hours, about 5 hours, about 6 hours, about 7 hours, about 8 hours, more than about 8 hours, etc. In some embodiments, the first solution is contacted 104 with the composition for about between about 1 minute and about 60 minutes. In some embodiments, the one or more reducing agents includes elemental vanadium, one or more vanadium compounds, elemental chromium, one or more chromium compounds, or combinations thereof. In some embodiments, the one or more chemical reducers includes V(II), Cr(II), or combinations thereof. In some embodiments, the chemical reducers include vanadium (II) sulfate. In some embodiments, the chemical reducers include chromium (II) chloride. In some embodiments, the reducing agent is present at a concentration between about 0.1 M and about 1.5 M. In some embodiments, the metal concentrate is treated with one or more acids, e.g., prior to contacting 104. In some embodiments, the one or more acids have a concentration between about 0.1 M and about 1.0 M. In some embodiments, the one or more acids includes between H₂SO₄.

At 106, a first leachate is isolated from the leached metal concentrate. In some embodiments, the first leachate includes iron, sulfur, or combinations thereof at an elevated concentration relative to the metal concentrate. In some embodiments, the first leachate includes iron, sulfur, or combinations thereof from the metal concentrate. Thus, steps 104 and 106 enable removal of undesired iron and sulfur components from a metal concentrate source, while allowing metals of interest such as nickel to remain in the leached metal concentrate. The first leachate can include in excess of 85% of the total iron originally present in the composition. In some embodiments, at least one of steps 104 and 106 occurs at about standard temperature, standard pressure, or combinations thereof. The leached metal concentrate is thus enriched for the target metal, and can be beneficial for use as a substitute for traditional high-quality ores in downstream processes such as smelting, particularly as high-quality ore deposits are depleted in response to increasing demand. At 108, the leached metal concentrate is recovered as a product enriched for the target metal.

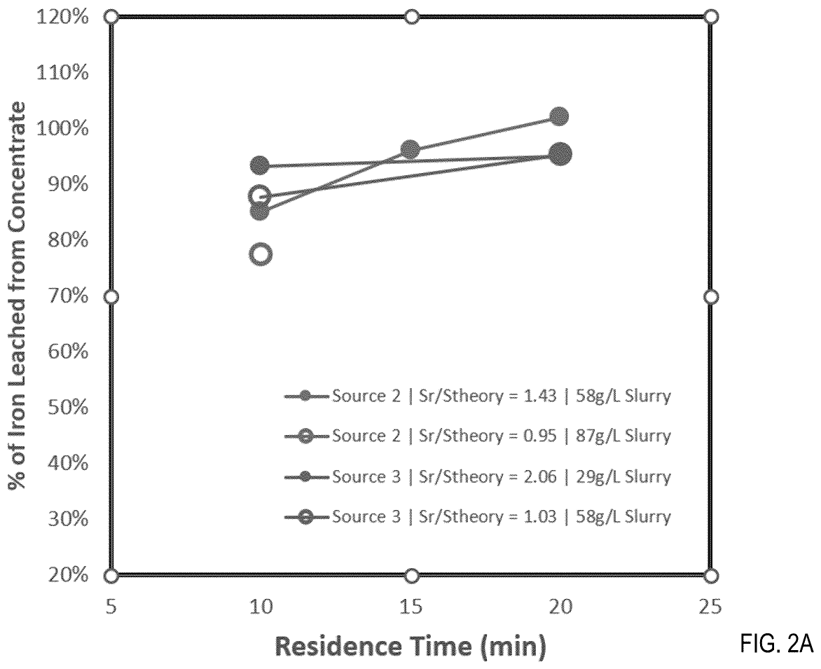

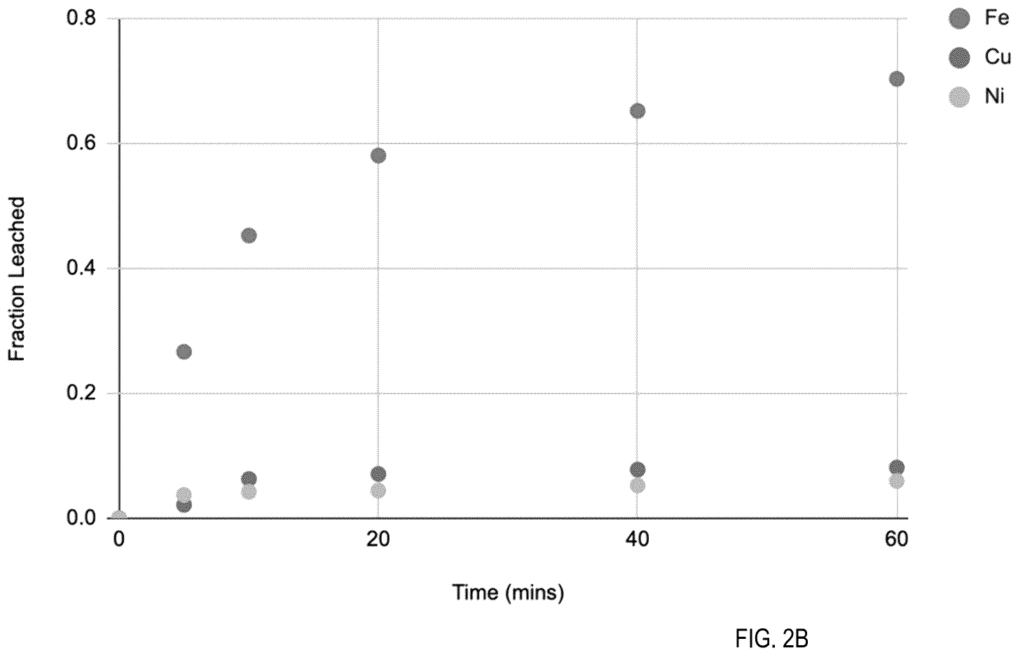

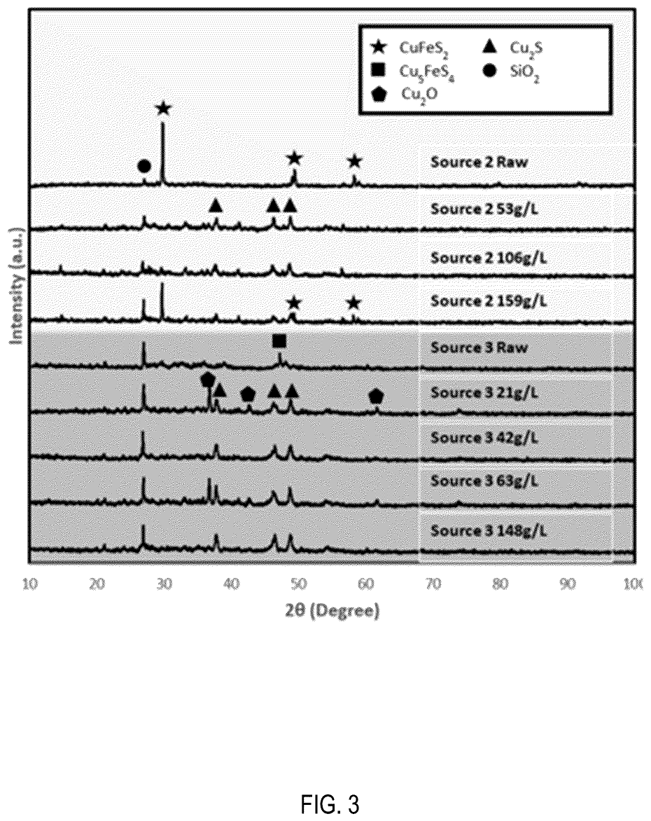

Referring now to FIGS. 2A-2B, the preferential leaching of iron from copper concentrates consistent with embodiments of the present disclosure is demonstrated. An exemplary tubular reactor setup was operated continuously to combine copper concentrates with a VSO₄ solution. Use of VSO₄ avoided the use of a chloride in this embodiment. After reaction, H₂S exited the system, and the solution was filtered. Copper concentrates from different sources demonstrated similar preferential iron leaching behaviors in response to reaction with chemical reducers consistent with embodiments of the present disclosure. The preferential leaching of iron from the copper concentrates relative to copper and nickel components is demonstrated in FIG. 2B. FIG. 3 shows an x-ray diffraction analysis of the solid leached metal concentrates after the V²⁺ leaching procedure. As shown, the solid leached metal concentrates comprise a final copper product (Cu or Cu₂) and an intermediate copper product (Cu₂S).

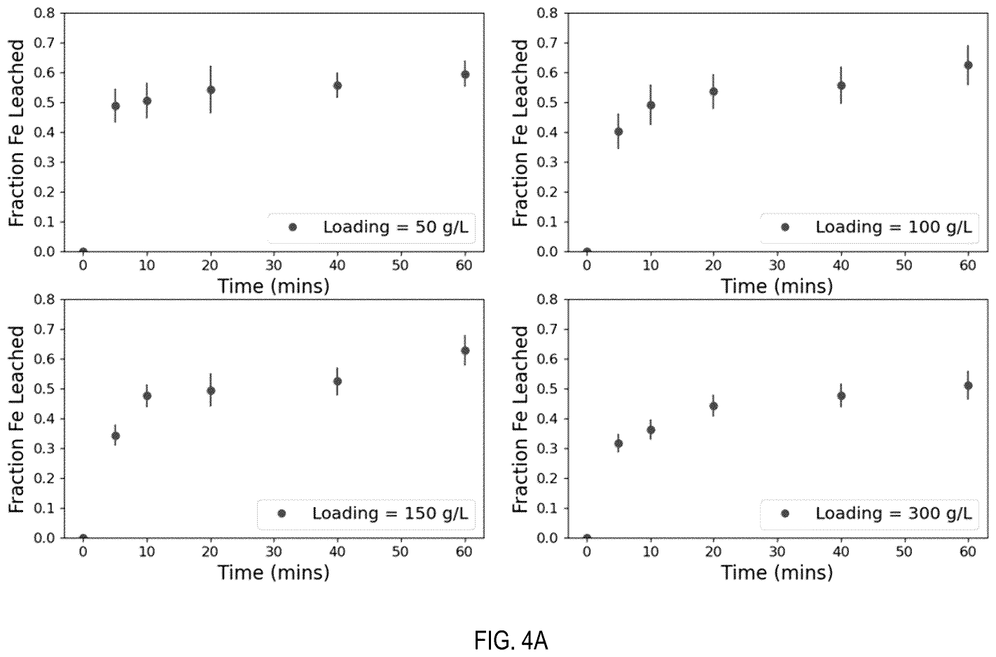

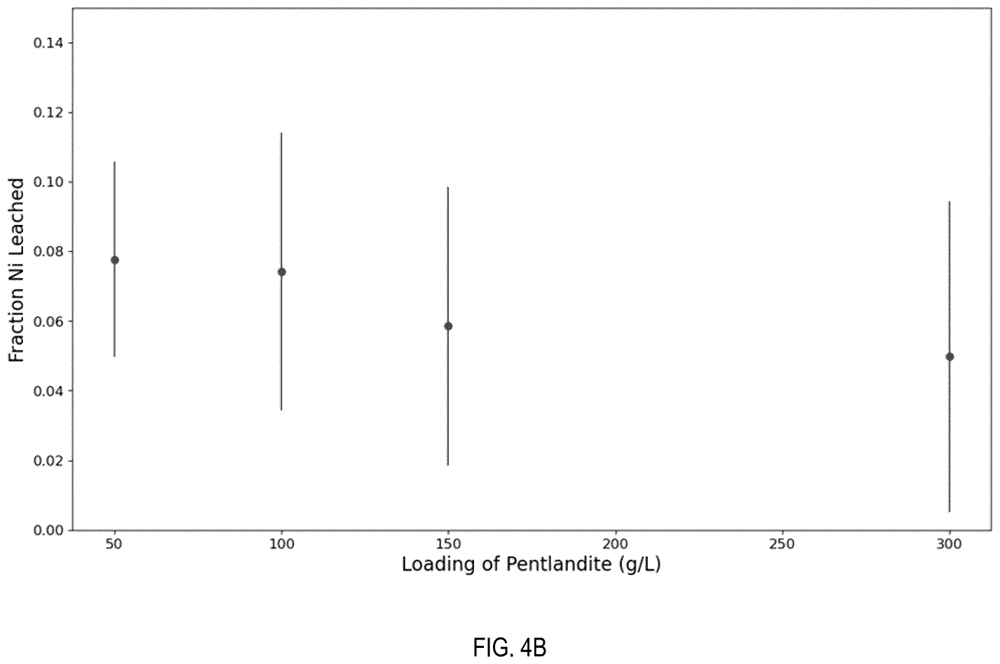

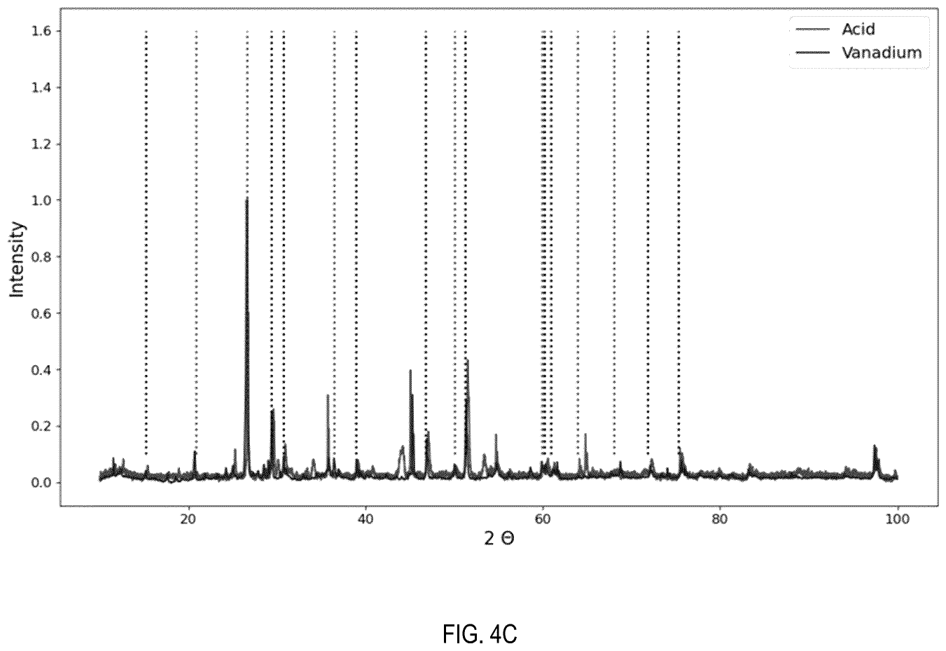

Referring now to FIGS. 4A-4B, preferential leaching of iron from nickel concentrates such as pentlandite consistent with embodiments of the present disclosure was also demonstrated. These figures show fractions of Fe and Ni leached for various pentlandite loadings over various reaction times, again demonstrating the preferential leaching of iron relative to that of the target metal, in this case nickel. FIG. 4C shows an x-ray diffraction analysis suggesting the presence of pentlandite and quartz throughout the reaction. Advantageously, embodiments of method 100 can transform metal concentrate starting materials with elevated concentrations of undesired components such as iron and sulfur and preferentially leach those components, such that removal of the resulting leachate leaves behind a metal concentrate with a recognizable composition, however enriched for one or more target metals.

Referring again to FIG. 1, at 110, the leached metal concentrate is contacted with a second solution. In some embodiments, the second solution is configured to leach one or more target components from the leached metal concentrate. In some embodiments, the second solution includes one or more chemical oxidizers. In some embodiments, the one or more chemical oxidizers includes Ce(IV), ferric iron ions, or combinations thereof. In some embodiments, at least a portion of the leached metal concentrate is reacted with the second solution, e.g., the chemical oxidizers. The reaction between the leached metal concentrate and the chemical oxidizers acts to preferentially leach target metals out of the leached metal concentrate, which can then be recovered as a metal-enriched leachate product. At 112, a second leachate is isolated. In some embodiments, the second leachate includes a target metal. In some embodiments, at 114, a target metal product is isolated from the second leachate.

Referring now to Table 1, exemplary embodiments of the methods of the present disclosure were performed to demonstrate sequential selective leaching of Fe and Ni from pentlandite via vanadium treatment followed by cerium treatment.

TABLE 1
Exemplary methods demonstrating sequential selective
leaching of iron and nickel from pentlandite.

| | Fraction | Fraction | | Fraction | Fraction |
|---|---|---|---|---|---|
| Leaching | of Fe | of Nickel | Leaching | of Fe | of Nickel |
| Step 1 | Leached | Leached | Step 2 | Leached | Leached |
| 1 hr. V(II) | 0.576 | 0.034 | 1 hr. Ce (IV) | 0.915 | 0.909 |
| Leach | | | Leach | | |
| 1 hr. Fe(III) | 0.021 | 0.048 | 1 hr. Ce (IV) | 0.434 | 0.328 |
| Leach | | | Leach | | |
| 1 hr. Sulfuric | 0.092 | 0.045 | 1 hr. Ce (IV) | 0.777 | 0.342 |
| Acid Leach | | | Leach | | |
| 1 hr. Ce (IV) | 0.360 | 0.183 | *Control* | | |
| Leach | | | | | |

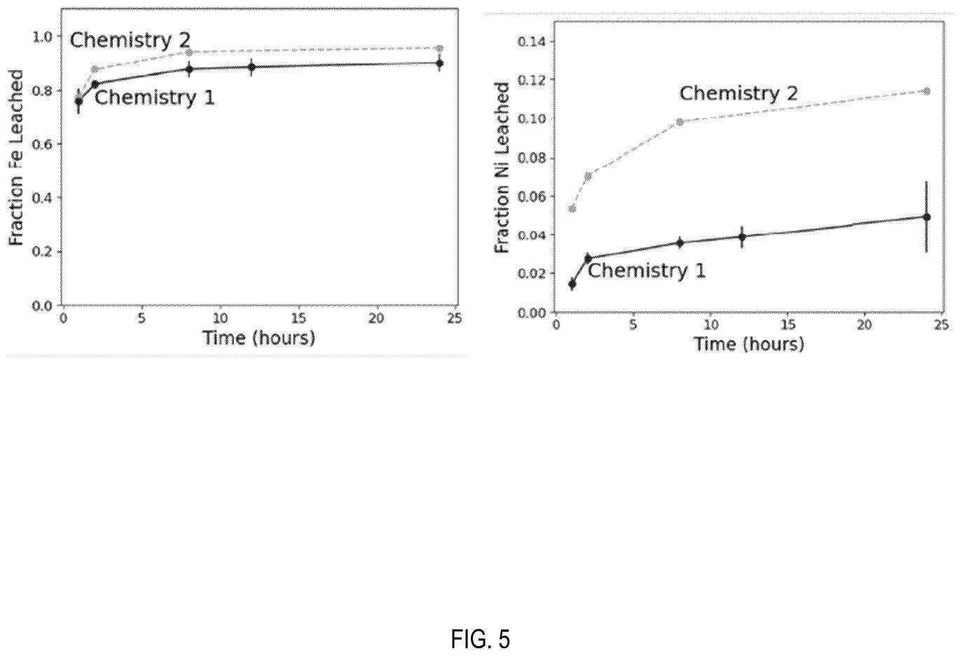

Referring now to FIG. 5 and Table 2, chemistries consistent with embodiments of the present disclosure were performed to demonstrate the selective leaching of iron and nickel from metal concentrates. These additional chemistries, identified as “Chemistry 1” and “Chemistry 2,” are identified in Table 3 below. About 90% of the iron was leached from the metal concentrate into solution. The leached metal concentrates demonstrated enrichment for nickel and lower concentrations of iron (see Table 2 below). In fact, the resulting leached nickel concentrates exhibited similar composition to nickel matte, a traded nickel intermediate.

TABLE 2
Concentrations of components in nickel metal concentrates.

| Composition | Chemistry | % | % | % | % |
|---|---|---|---|---|---|
| As Tested | Used | Fe | Ni | Cu | Co |
| Nickel | N/A | 43.1% | 14.8% | 1.1% | 0.32% |
| Concentrate | | | | | |
| 1 hour leach | Chemistry 1 | 25.8% | 25.4% | 0.97% | 0.53% |
| | Chemistry 2 | 24.6% | 26.2% | 0% | 0.57% |
| 2-hour leach | Chemistry 1 | 15.3% | 30.3% | 0.87% | 0.54% |
| | Chemistry 2 | 22.4% | 27.5% | 0% | 0.50% |
| 4-hour leach | Chemistry 1 | 9.8% | 33.5% | 1.4% | 0.57% |
| | Chemistry 2 | 10.9% | 32.3% | 0% | 0.50% |
| 8-hour leach | Chemistry 1 | 6.5% | 35.6% | 1.8% | 0.53% |
| | Chemistry 2 | 6.1% | 40.9% | 0% | 0.57% |
| Double leach | Chemistry 1 | 3.9% | 39.2% | | |

TABLE 3
Exemplary chemical reduction chemistries for preferential
leaching of iron and sulfur components from metal concentrates
consistent with embodiments of the present disclosure.

| | Reducing Agent | Solvent | Creation Method |
|---|---|---|---|
| Chemistry 1 | 0.1-1.5M | 0.1-1.5M | Flow battery, cathode |
| | V(II) | Sulfuric Acid | VSO₄ in Sulfuric Acid |
| | | | Anode FeSO₄ |
| Chemistry 2 | 0.1-1.5M | 0.1-1.5M | Mixing CrCl₂ with 1M |
| | CrCl₂ | Sulfuric Acid | Sulfuric Acid |

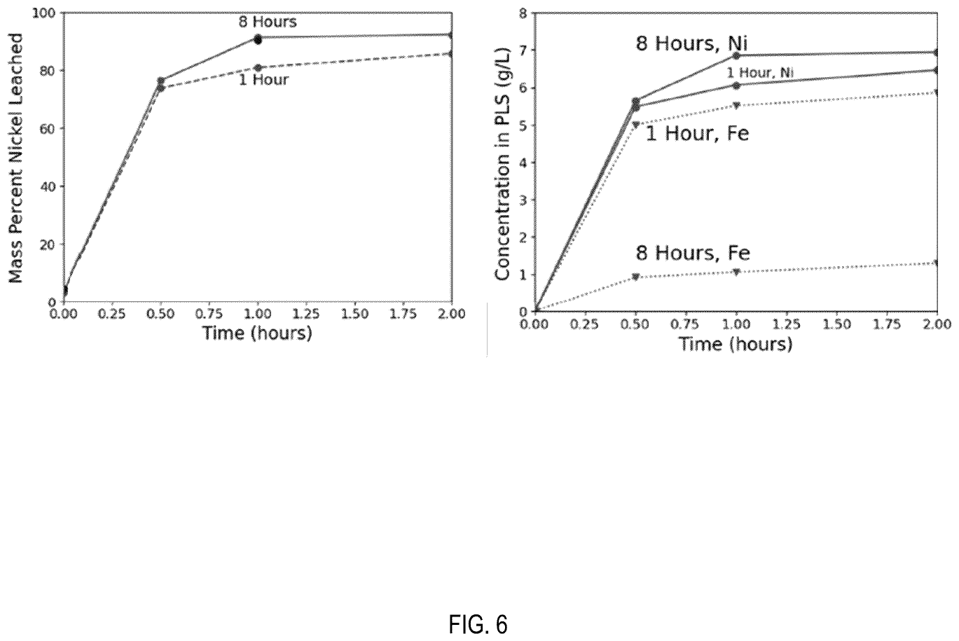

Referring now to FIG. 6, additional reaction with chemical oxidizers resulted in about 90% recovery of overall nickel from the nickel metal concentrates in the second leachate. These metal recovery results were obtained while operating at room temperature and pressure.

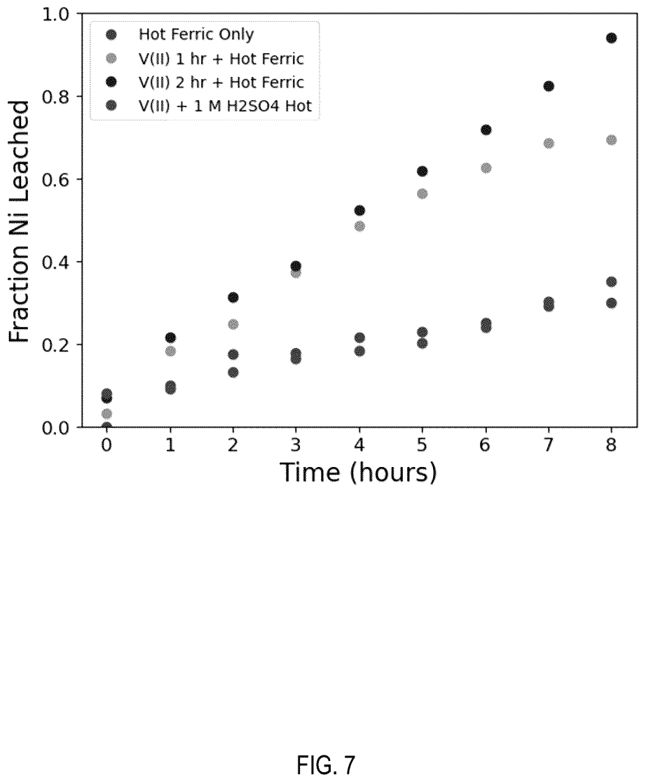

Referring now to FIG. 7, ferric oxidant at 80° C. was demonstrated as a chemical oxidizer consistent with some embodiments of the present disclosure. Without wishing to be bound by theory, kinetics were shown to be slower than cerium, and utilized elevated temperatures and nearly 8 hours of reaction time.

Referring again to FIG. 1, in some embodiments, at 116, a concentration of a reduced chemical oxidizer is isolated. In some embodiments, the reduced chemical oxidizer is produced as a result of the reaction at contacting step 110. In some embodiments, at 118, at least a portion of the reduced chemical oxidizer is provided to an electrochemical device. In some embodiments, at 120, the reduced chemical oxidizers at the electrochemical device are oxidized to a concentration of recycled chemical oxidizer. The recycled chemical oxidizer can then be reused in the leaching of additional amounts of leached metal concentrates, helping to reduce material costs and wastes associated with the embodiments of the present disclosure. In some embodiments, at 122, at least a portion of the recycled chemical oxidizer is contacted with the leached metal concentrate. In some embodiments (not pictured), oxidized chemical reducers are similarly electrochemically treated to produce amounts of recycled chemical reducers, which can then be used in the leaching of additional metal concentrates, e.g., at contacting step 104.

In some embodiments, the leached metal concentrate is contacted with an additional solution including a concentration of ferric iron ions. In some embodiments, an additional leachate is isolated from the leached metal concentrate. In some embodiments, the additional leachate includes copper at an elevated concentration relative to the leached metal concentrate. Greater than 99% of copper present in metal concentrates can be recovered in leachate streams utilizing at the least the chemical reducer/ferric iron ion leaching according to embodiments of the present disclosure. Thus, these embodiments can beneficially recover myriad products from what can be considered “low-quality” metal concentrates, either as the product itself, e.g., metal products, or an enriched feedstocks for use in other downstream processes, e.g., enriched nickel-containing ores.

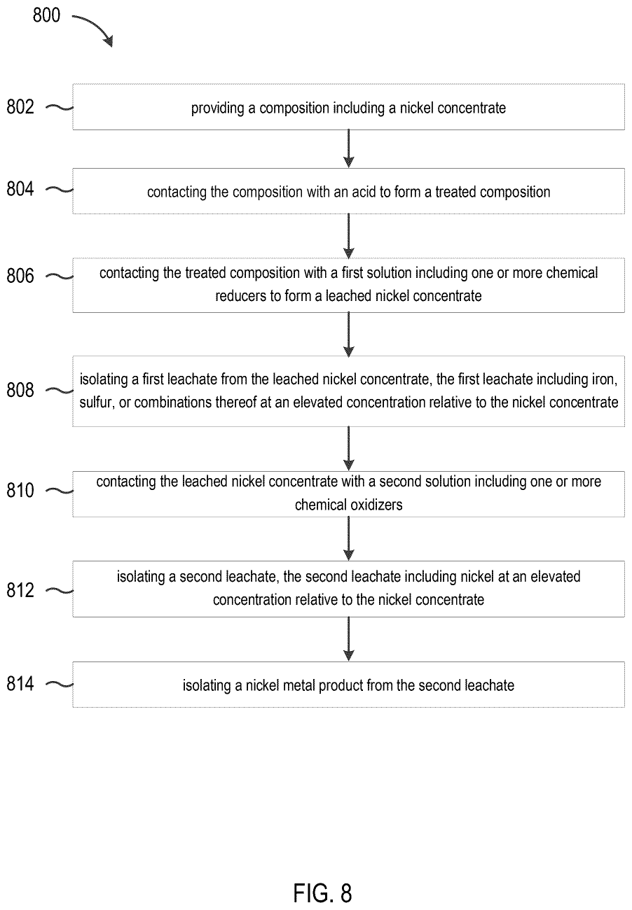

Referring now to FIG. 8, some embodiments of the present disclosure is directed to a method 800 of leaching one or more metals from sulfide-containing minerals. In some embodiments, at 802, a composition including a nickel concentrate is provided. In some embodiments, the nickel concentrate includes pentlandite, pyrrhotite, Cu Rougher Tails, or combinations thereof. At 804, the composition is contacted with one or more acids. As discussed above, in some embodiments, the acid includes between about 0.1 M and about 1.0 M H₂SO₄. In some embodiments, contacting 804 with the acid forms a treated composition. In some embodiments, at 806, the treated composition is contacted with a first solution. As discussed above, in some embodiments, the first solution includes one or more chemical reducers. In some embodiments, the chemical reducers include V(II), Cr(II), or combinations thereof. The chemical reducers react at least with nickel concentrates in the composition, forming a first leachate including iron, sulfur, or combinations thereof from the nickel concentrate, and at elevated concentrations relative to the nickel concentrate. Contacting 806 also forms a leached nickel concentrate. At 808, the first leachate is isolated from the leached nickel concentrate.

In some embodiments, at 810, the leached nickel concentrate is contacted with a second solution including one or more chemical oxidizers. In some embodiments, the chemical oxidizers include Ce(IV), ferric iron ions, or combinations thereof. The chemical oxidizers react at least with the leached nickel concentrate forming a second leachate including nickel from the leached nickel concentrate, and at elevated concentrations relative to the nickel concentrate. At 812 the second leachate is isolated. At 814, in some embodiments, a nickel metal product is isolated from the second leachate via any suitable process, e.g., electrowinning.

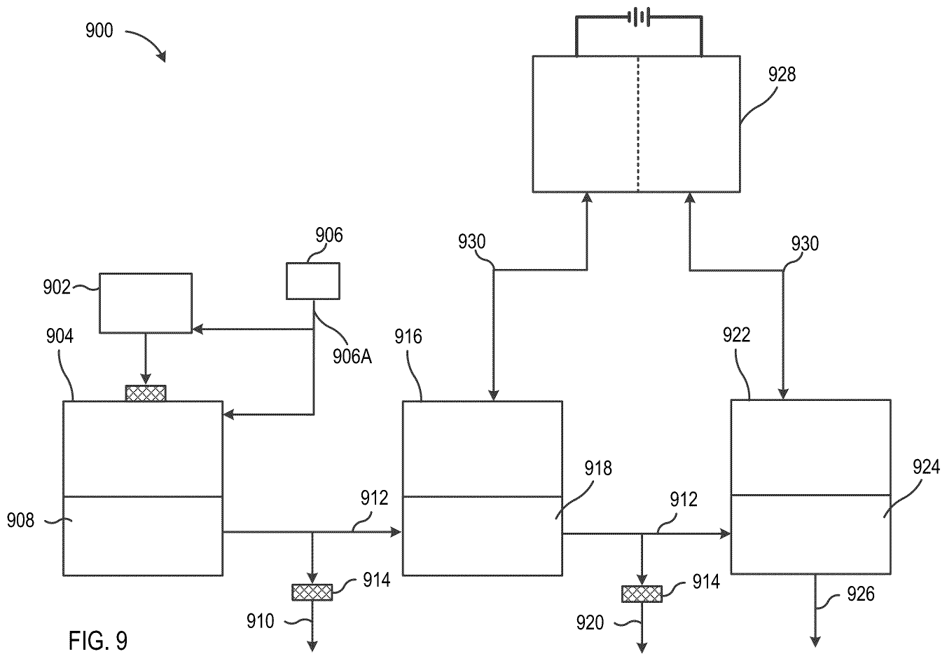

Referring now to FIG. 9, some embodiments of the present disclosure are directed to a system 900 for leaching one or more metals from sulfide-containing minerals, e.g., to form enriched metal concentrates, recover metal products, etc., or combinations thereof. In some embodiments, system 900 includes a source 902 of a composition including one or more metal concentrates. As discussed above, in some embodiments, the composition includes a concentration of iron, a concentration of sulfur, and a concentration of a target metal. In some embodiments, the target metal includes nickel, cobalt, or combinations thereof.

In some embodiments, source 902 is naturally occurring, man-made, or combinations thereof. In some embodiments, the metal concentrate is a metal-containing mineral or combination of metal-containing minerals. In some embodiments, the metal concentrate is naturally occurring, man-made, or combinations thereof. In some embodiments, the metal concentrate includes pentlandite, pyrrhotite, Cu Rougher Tails, or combinations thereof. In some embodiments, the metal concentrate also includes copper. In some embodiments, the metal concentrate also includes chalcopyrite.

In some embodiments, system 900 includes one or more reduction reactors 904 in communication with source 902. In some embodiments, system 900 includes a plurality of reduction reactors 904. In some embodiments, a plurality of reduction reactors 904 are arranged in series. In some embodiments, reduction reactors 904 are in fluid communication with a source of one or more acids 906. In some embodiments, source 902 is in direct communication with acid source 906. In some embodiments, system 900 includes an acid inlet stream 906A configured to contact the composition with acid from acid source 906, e.g., in reduction reactor 904, at source 902, in a separate reaction vessel (not pictured), etc. or combinations thereof. In some embodiments, the acid, e.g., in acid inlet stream 906A, includes between about 0.1 M and about 1.0 M H₂SO₄.

In some embodiments, reduction reactor 904 includes a first solution 908. As discussed above, in some embodiments, first solution 908 includes one or more chemical reducers. In some embodiments, the one or more chemical reducers includes V(II), Cr(II), or combinations thereof. In some embodiments, system 900 includes a first leachate effluent stream 910. As discussed above, in some embodiments, the first leachate effluent stream includes iron, sulfur, or combinations thereof at an elevated concentration relative to the metal concentrate, e.g., from source 902. In some embodiments, system 900 includes a leached metal concentrate stream 912 including a product enriched for the target metal relative to the metal concentrate. In some embodiments, first leachate effluent stream 910 and leached metal concentrate stream 912 are removed from reduction reactor 904. In some embodiments, first leachate effluent stream 910 and leached metal concentrate stream 912 are separated via one or more filters 914.

In some embodiments, system 900 includes one or more leachate reactors 916. In some embodiments, leachate reactor 916 is in fluid communication with leached metal concentrate stream 912. In some embodiments, leachate reactor 916 includes a leach solution 918 having a concentration of ferric iron ions. In some embodiments, system 900 includes an additional leachate effluent stream 920. In some embodiments, additional leachate effluent stream 920 includes elevated concentrations of copper relative to source 902. In some embodiments, source 902 includes chalcopyrite.

In some embodiments, system 900 includes one or more oxidation reactors 922. In some embodiments, oxidation reactor 922 is in fluid communication with leached metal concentrate stream 912. In some embodiments, oxidation reactor 922 is in fluid communication with leachate reactor 916. In some embodiments, oxidation reactor 922 includes a second solution 924. In some embodiments, second solution 924 includes one or more chemical oxidizers. In some embodiments, the one or more chemical oxidizers includes Ce(IV), ferric iron ions, or combinations thereof. In some embodiments, system 900 includes a second leachate effluent stream 926. In some embodiments, second leachate effluent stream 926 includes elevated concentrations of nickel relative to source 902.

In an exemplary embodiment of system 900, pentlandite is subjected to vanadium (II) and Ce(IV) leaching. First, raw pentlandite, e.g., from source 902, is reacted with sulfuric acid, e.g., via contact with acid inlet stream 906A. This solution is then filtered, e.g., via a filter 914, and then reacted in reduction reactor 904 with V²⁺ to leach iron out of the pentlandite, forming a first leachate effluent stream 910 that can be removed from the reduction reactor, e.g., through another filter 914, leaving behind a Ni-rich product. The Ni-rich product is transported as leached metal concentrate stream 912 to leachate reactor 916 where it is further treated with ferric iron ions in leach solution 918. Copper in the Ni-rich product can be leached therefrom and removed as additional leachate effluent stream 920 enriched with said copper. The Ni-rich product can then be transported to oxidation reactor 922 and contacted with chemical oxidizers from second solution 924. Nickel in the Ni-rich product can then be recovered as second leachate effluent stream 926, which can be transported to an electrowinning system (not pictured) for recovery of a nickel metal product.

In some embodiments, system 900 includes an electrochemical device 928 in communication with reduction reactor 904, oxidation reactor 922, or combinations thereof. As discussed above, electrochemical device 928 is configured to electrochemically replenish the chemical reducers and chemical oxidizers for reuse in reduction reactor 904 and oxidation reactor 922, respectively. In some embodiments, the electrochemical device includes at least one pair of electrodes, e.g., a cathode and an anode, in electrical communication via one or more electrolytes, and a power supply configured to apply an electrical potential across the device, e.g., the electrodes. In some embodiments, system 900 includes one or more recycle streams 930 configured to return recycled chemical reducers to reduction reactor 904, recycled chemical oxidizers to oxidation reactor 922, or combinations thereof.

Systems and methods of the present disclosure advantageously react metal concentrates with chemical reducers and chemical oxidizers to enrich the metal concentrates for target metals such as nickel. As demand for nickel-containing products increases, the availability of high-quality nickel containing ores is decreasing. While lower quality ores are still available, they may be unsuitable for use in traditional smelting systems, or require longer processing times or result in lower metal product yields, increased the associated cost of any nickel-containing product developed from the ores. Ni-sulfide minerals can be treated with one or more acids and then contacted with one or more chemical reducers consistent with embodiments of the present disclosure, e.g., V(II), selectively leaching a stream enriched for iron and sulfur components from the minerals and leaving behind an enriched mineral. In this manner, minerals such as low-quality pentlandite can be converted to higher-quality nickel concentrates desirable for use in smelting processes. The enriched minerals can be further reacted with one or more chemical oxidizers, e.g., Ce(IV), which leach additional streams enriched for the target metal itself, e.g., nickel. Additional leaching of copper product streams from the enriched metal concentrates with ferric iron ions is also enabled. The embodiments of the present disclosure can be conducted at reasonable pressures and temperatures compared to traditional methods, and therefore enable higher yield and improved production methods of Ni metal and/or alternative Ni products. The selective removal process works well even at high loadings of solids.

Metal products can then be recovered from these additional streams, e.g., by electrowinning. Advantageously, both the chemical reducers and oxidizers can be replenished electrochemically for reuse in subsequent reaction processes with additional metal concentrates, decreasing the overall costs and material wastes associated with the embodiments of the present disclosure. These systems and methods enable domestic production of nickel as an alternative to pyrometallurgical or autoclave processing, which has multiple environmental/climate impacts, and are beneficial for implementation related to battery production, the mining industry, clean technologies, etc.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A method of leaching one or more metals from sulfide-containing minerals, comprising:
providing a composition including one or more metal concentrates, the composition including a concentration of iron, a concentration of sulfur, and a concentration of a target metal;
reacting the metal concentrate with a first solution including one or more chemical reducers to form a leached metal concentrate;
isolating a first leachate from the leached metal concentrate, the first leachate including iron, sulfur, or combinations thereof at an elevated concentration relative to the metal concentrate; and
recovering the leached metal concentrate as a product enriched for the target metal,
wherein the metal concentrate includes pentlandite, pyrrhotite, Cu Rougher Tails, or combinations thereof.

2. The method according to claim 1, wherein the target metal includes nickel, cobalt, or combinations thereof.

3. The method according to claim 1, wherein the one or more chemical reducers includes V(II), Cr(II), or combinations thereof.

4. The method according to claim 1, further comprising treating the metal concentrate with one or more acids, wherein the one or more acids includes between about 0.1 M and about 1.0 M H₂SO₄.

5. The method according to claim 1, further comprising:
contacting the leached metal concentrate with a second solution including one or more chemical oxidizers;
isolating a second leachate, the second leachate including a target metal; and
isolating a target metal product from the second leachate.

6. The method according to claim 5, further comprising:
isolating a concentration of a reduced chemical oxidizer;
providing at least a portion of the reduced chemical oxidizer to an electrochemical device;
oxidizing the reduced chemical oxidizers at the electrochemical device to a concentration of recycled chemical oxidizer; and
contacting at least a portion of the recycled chemical oxidizer with the leached metal concentrate.

7. The method according to claim 5, wherein the one or more chemical oxidizers includes Ce(IV), ferric iron ions, or combinations thereof.

8. The method according to claim 1, wherein the metal concentrate further comprises chalcopyrite.

9. The method according to claim 8, further comprising:
contacting the leached metal concentrate with an additional solution including a concentration of ferric iron ions; and
isolating an additional leachate from the leached metal concentrate, the additional leachate including copper at an elevated concentration relative to the leached metal concentrate.

10. The method according to claim 1, wherein reacting the metal concentrate with a first solution including one or more chemical reducers to form a leached metal concentrate occurs at about standard temperature, standard pressure, or combinations thereof.

11. The method according to claim 1, wherein reacting the metal concentrate with a first solution including one or more chemical reducers to form a leached metal concentrate has a reaction time between about 1 minute and about 60 minutes.

12. A system for leaching one or more metals from sulfide-containing minerals, comprising:
a source of a composition including one or more metal concentrates, the composition including a concentration of iron, a concentration of sulfur, and a concentration of a target metal;
one or more reduction reactors in communication with the source of a composition and including a first solution, the first solution including one or more chemical reducers;
a first leachate effluent stream, the first leachate effluent stream including iron, sulfur, or combinations thereof at an elevated concentration relative to the metal concentrate; and
a leached metal concentrate stream including a product enriched for the target metal relative to the metal concentrate,
wherein the metal concentrate includes pentlandite, pyrrhotite, Cu Rougher Tails, or combinations thereof.

13. The system according to claim 12, wherein the target metal includes nickel, cobalt, or combinations thereof.

14. The system according to claim 12, wherein the one or more chemical reducers includes V(II), Cr(II), or combinations thereof.

15. The system according to claim 12, further comprising an acid inlet stream in fluid communication with the reduction reactor, the acid including between about 0.1 M and about 1.0 M H₂SO₄.

16. The system according to claim 12, further comprising one or more oxidation reactors in communication with the leached metal concentrate stream and including a second solution, the second solution including one or more chemical oxidizers.

17. The system according to claim 16, wherein the one or more chemical oxidizers includes Ce(IV), ferric iron ions, or combinations thereof.

18. The system according to claim 16, further comprising:
an electrochemical device in fluid communication with the reduction reactor, the oxidation reactor, or combinations thereof, and
one or more recycle streams configured to return recycled chemical reducers to the reduction reactor, recycled chemical oxidizers to the oxidation reactor, or combinations thereof.

19. The system according to claim 17, further comprising an additional leachate effluent stream, the additional leachate effluent stream including copper at an elevated concentration relative to the metal concentrate,
wherein the metal concentrate further comprises chalcopyrite.

20. A method of leaching one or more metals from sulfide-containing minerals, comprising:
providing a composition including a nickel concentrate;
contacting the composition with an acid to form a treated composition, the acid including between about 0.1 M and about 1.0 M H₂SO₄;
contacting the treated composition with a first solution including one or more chemical reducers to form a leached nickel concentrate;
isolating a first leachate from the leached nickel concentrate, the first leachate including iron, sulfur, or combinations thereof at an elevated concentration relative to the nickel concentrate;
contacting the leached nickel concentrate with a second solution including one or more chemical oxidizers;
isolating a second leachate, the second leachate including nickel at an elevated concentration relative to the nickel concentrate; and
isolating a nickel metal product from the second leachate,
wherein the one or more chemical reducers includes the one or more chemical reducers includes V(II), Cr(II), or combinations thereof, and the one or more chemical oxidizers includes Ce(IV), ferric iron ions, or combinations thereof,
wherein the nickel concentrate includes pentlandite, pyrrhotite, Cu Rougher Tails, or combinations thereof.
